(19) United States
(12) Patent Application Publication
(10) Pub. No.: US 2021/0230401 A1
(43) Pub. Date: Jul. 29, 2021

(54) RUBBER COMPOSITION COMPRISING A POLYPHENYLENE ETHER RESIN AS A PLASTICIZER

(71) Applicant: COMPAGNIE GENERALE DES ETABLISSEMENTS MICHELIN, Clermont-Ferrand (FR)

(72) Inventors: MATHILDE ABAD, Clermont-Ferrand (FR); SALVATORE PAGANO, Clermont-Ferrand (FR)

(21) Appl. No.: 16/757,597

(22) PCT Filed: Oct. 17, 2018
(86) PCT No.: PCT/FR2018/052585

§ 371 Date: Apr. 20, 2020

(30) Foreign Application Priority Data
Oct. 20, 2017 (FR) 1759919

(51) Int. Cl. C08L 9/06; C08K 3/04; C08L 71/12; B60C 1/00; C08K 3/011; C08K 3/36

(52) U.S. Cl. CPC C08L 9/06; C08K 3/04; C08K 3/36; B60C 1/0016; C08K 3/011; C08L 71/123

(57) ABSTRACT

A rubber composition is based on at least one predominant vinylaromatic diene elastomer, a reinforcing filler, a crosslinking system, and a polyphenylene ether resin which has a number-average molecular mass (Mn) within a range from 800 to 1500 g/mol and a general formula (I):

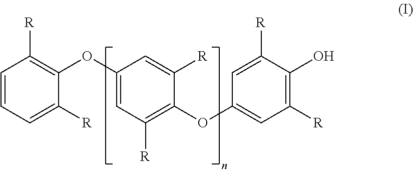

in which the groups R independently of one another represent a hydrogen atom or an alkyl radical and n is between 6 and 12. Semi-finished tire products and tires comprise this composition.

The present invention pertains to rubber compositions which are intended particularly for the manufacture of tyres or of semi-finished products for tyres, more particularly to rubber compositions for tyre treads where the mixtures are very easy to manufacture and in tyre form have good wear resistance.

Tyres in use are subject to many stresses. The tyre treads in particular have to meet a host of technical demands, which are often in conflict with one another, including high wear resistance and good grip under both wet and dry road conditions. The mixtures for these tyres are also required to have good processing qualities, meaning that they must be easy to manufacture.

It is known practice to use elastomers in the tyre compositions, in combination with reinforcing fillers and plasticizing agents. Conventionally, these plasticizing agents may be plasticizing oils or plasticizing resins, as described in numerous documents, for example in patent applications FR 2866028, FR 2877348 or FR 2889538, which describe in particular the use of thermoplastic resins as plasticizing resins.

Furthermore, in document WO2015/091921, the Applicant described a rubber composition based on at least one predominant vinylaromatic diene elastomer, a reinforcing filler, a crosslinking system, and a thermoplastic resin comprising optionally substituted polyphenylene ether units, said resin having a number-average molecular mass (Mn) of less than 6000 g/mol. The examples propose resins presented with an Mn of 2350 g/mol and of 1800 g/mol, for example. This document indicates that the use of such a resin has the surprisingly result of enhancing the performance trade-off between ease of manufacture of the mixtures and grip of the tyres. Moreover, the use of these thermoplastic resins based on optionally substituted polyphenylene ether units reduces the amount of resin, relative to conventional plasticizing thermoplastic resins, so enabling a reduction in the green tack of the compositions, which is linked to the use of these resins, and so making it easier to manufacture tyres comprising these compositions.

The Applicant has now found that a specific selection from known resins comprising polyphenylene ether units makes it possible to achieve a further shift in the glass transition of the mixture and so to reduce the amount of conventional thermoplastic resin contained in the mixture.

A first subject of the invention therefore relates to a rubber composition based on at least one predominant vinylaromatic diene elastomer, a reinforcing filler, a crosslinking system, and a polyphenylene ether resin which has a number-average molecular mass (Mn) within a range from 800 to 1500 g/mol and a general formula (I)

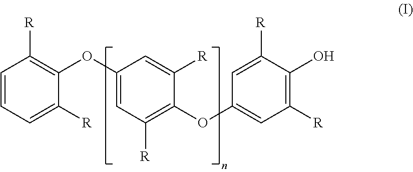

in which the groups R independently of one another represent a hydrogen atom or an alkyl radical and n is between 6 and 12.

The invention preferably relates to a composition as defined above wherein said resin has a number-average molecular mass (Mn) within a range from 800 to 1300 g/mol, more preferably within a range from 800 to 1100 g/mol.

The invention preferably relates to a composition as defined above wherein the vinylaromatic diene elastomer has a vinylaromatic content of more than 10%, preferably of between 10% and 50%, more preferably between 10% and 30%, very preferably between 12% and 28%, and more preferably still between 14% and 20%.

The vinylaromatic diene elastomer is preferably selected from the group consisting of copolymers of butadiene and styrene, copolymers of isoprene and styrene, copolymers of butadiene, isoprene and styrene, and mixtures of these elastomers, and preferably from the group consisting of copolymers of butadiene and styrene, and mixtures of the latter. The vinylaromatic diene elastomer content is likewise preferably within a range from 70 to 100 phr (parts by weight per hundred parts of elastomer), and more preferably from 85 to 100 phr.

The invention preferably relates to a composition as defined above wherein the polyphenylene ether resin has a glass transition temperature (Tg), measured by DSC according to standard ASTM D3418 from 1999, within a range from 0 to 130° C., preferably from 5 to 115° C. and more preferably from 5 to 100° C.

The invention preferably relates to a composition as defined above wherein the polyphenylene ether resin has the general formula (I) in which the groups R all represent a hydrogen atom or all represent an identical alkyl radical.

The invention preferably relates to a composition as defined above wherein the groups R represent a methyl radical.

The invention preferably relates to a composition as defined above wherein n is between 7 and 10.

The invention preferably relates to a composition as defined above wherein the content of said polyphenylene ether resin is within a range from 1 to 90 phr, preferably from 2 to 80 phr, more preferably from 3 to 60 phr, better still from 5 to 60 phr.

The invention preferentially relates to a composition as defined above wherein the reinforcing filler comprises carbon black and/or silica.

The invention likewise preferentially relates to a composition as defined above wherein the reinforcing filler represents between 20 and 200 phr, more preferably between 30 and 160 phr.

The invention preferably relates to a composition as defined above wherein the reinforcing filler comprises predominantly carbon black. The carbon black preferably represents from 60 to 160 phr, more preferably from 70 to 150 phr.

Alternatively and likewise preferably, the invention relates to a composition as defined above wherein the reinforcing filler comprises predominantly silica. The silica preferably represents from 60 to 160 phr, more preferably from 70 to 150 phr.

A further subject of the invention are finished or semi-finished rubber articles comprising a rubber composition in accordance with the invention.

A further subject of the invention are tyres comprising a rubber composition in accordance with the invention, and especially tyres wherein the tread comprises a rubber composition according to the invention.

Tyres in accordance with the invention are intended in particular for passenger vehicles such as for two-wheel vehicles (motorcycles, bicycles), industrial vehicles selected from vans, “heavy-duty” vehicles—i.e., underground, bus, and heavy road transport vehicles (lorries, tractors, trailers), off-road vehicles, heavy agricultural vehicles or earthmoving equipment, aircraft, and other vehicles for transport or handling.

The invention and the advantages thereof will be readily understood in the light of the description and the exemplary embodiments which follow.

I. Tests

I.1. Dynamic Properties After Curing

The rubber compositions are characterized after curing, as indicated below.

The dynamic properties G* are measured on a viscosity analyser (Metravib VA4000) according to standard ASTM D 5992-96. The analyser records the response of a sample of vulcanized composition (i.e. a composition cured to a conversion rate of at least 90%) (cylindrical specimen with a thickness of 2 mm and a cross section of 78.5 mm²), which is subjected to a simple alternating sinusoidal shear stress, at a frequency of 10 Hz.

A temperature sweep is carried out at a constant temperature rise rate of +1.5° C./min with an imposed peak-to-peak shear stress of 0.7 MPa. The specimen is subjected to sinusoidal shear stress at 10 Hz symmetrically about its equilibrium position. The results utilized are the complex dynamic shear modulus (G*) and the viscous component of the shear modulus (G″) denoted G″(T).

The glass transition temperature (denoted Tg) according to the invention corresponds to the temperature at which the maximum observed G″ is observed during the temperature sweep. Hence, in the present description, unless expressly indicated otherwise, the Tg is defined as the temperature at which the maximum G″ is observed (with G″ representing, in a known way, the viscous component of the shear modulus) during the temperature sweep of a crosslinked sample subjected to an imposed sinusoidal shear stress of 0.7 MPa at a frequency of 10 Hz. As indicated above, this Tg is measured during the measurement of dynamic properties, on a viscosity analyser (Metravib VA4000), according to standard ASTM D 5992-96.

I.2. Measurement of Molecular Mass (GPC)

The molecular mass of the PPE resins is measured as indicated below.

The SEC (Size Exclusion Chromatography) technique allows macromolecules in solution to be separated according to their size, through columns which are filled with a porous gel. The macromolecules are separated according to their hydrodynamic volume, with those having the greatest volume being eluted first.

Without being an absolute method, SEC gives an idea of the distribution of the molecular masses of a polymer. Starting from commercial standard products, the various number-average (Mn) and weight-average (Mw) molar masses can be determined and the polymolecularity index (Ip=Mw/Mn) calculated by way of MOORE calibration.

The polymer sample undergoes no special treatment before analysis. It is simply dissolved in the elution solvent at a concentration of approximately 1 g/l. The solution is then filtered on a 0.45 μm porosity filter before being injected.

The apparatus used is a Waters alliance chromatographic system. The eluted solvent is tetrahydrofuran without antioxidant, the flow rate is 1 mL.min-1, the temperature of the system is 35° C. and the time for analysis is 45 min. The columns used are a set of four Agilent columns comprising two with the tradename PL GEL MIXED D and two with the tradename PL GEL MIXED E. The volume of the polymer sample solution injected is 100 μl. The detector is a Waters 2410 differential refractometer, and the software for interpreting the chromatographic data is the Waters Empower system.

The calibrated average molar masses relate to a calibration curve formed on the basis of standard polystyrenes.

II. Conditions for Implementing the Invention

The rubber composition according to the invention is based on at least one predominant vinylaromatic diene elastomer, a reinforcing filler, a crosslinking system, and a polyphenylene ether resin which has a number-average molecular mass (Mn) within a range from 800 to 1500 g/mol and a general formula (I)

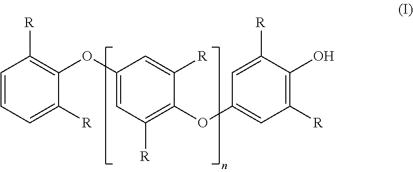

in which the groups R independently of one another represent a hydrogen atom or an alkyl radical and n is between 6 and 12.

The expression composition “based on” should be understood as meaning a composition comprising the mixture and/or the reaction product of the various constituents used, with some of these base constituents being capable of reacting or being intended to react with one another, at least in part, during the various phases of manufacture of the composition, in particular during the crosslinking or vulcanization thereof.

In the present description, unless expressly indicated otherwise, all of the percentages (%) indicated are percentages (%) by mass. Furthermore, any interval of values designated by the expression “between a and b” represents the range of values extending from more than a to less than b (i.e. endpoints a and b excluded), whereas any interval of values designated by the expression “from a to b” signifies the range of values extending from a up to b (i.e. including the strict endpoints a and b).

When reference is made to a “predominant” compound, what is meant, in the sense of the present invention, is that this compound is predominant among the compounds of the same type in the composition, in other words that it is the compound which represents the greatest amount by mass among the compounds of the same type. Thus, for example, a predominant elastomer is the elastomer which represents the greatest mass relative to the total mass of the elastomers in the composition. In the same way, a predominant filler is that which represents the greatest mass among the fillers of the composition. As an example, in a system comprising a single elastomer, that elastomer is predominant within the meaning of the present invention, and, in a system comprising two elastomers, the predominant elastomer represents more than half of the mass of the elastomers.

II.1. Elastomers

The rubber composition according to the invention comprises a predominant vinylaromatic diene elastomer.

The term “diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These definitions being given, the term “vinylaromatic diene elastomer” more particularly means any copolymer obtained by copolymerization of one or more conjugated dienes with one another or with one or more vinylaromatic compounds having from 8 to 20 carbon atoms,

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene, 2-methyl-3-isopropyl-1,3-butadiene, aryl-1,3-butadiene, 1,3-pentadiene or 2,4-hexadiene.

The following, for example, are suitable as vinylaromatic compounds: styrene, alpha-methylstyrene, ortho-, meta- or para-methylstyrene, the “vinyltoluene” commercial mixture, para-tert-butyl styrene, methoxystyrenes, chlorostyrenes, vinylmesitylene, divinylbenzene and vinylnaphthalene.

The copolymers may contain between 99% and 20% by weight of diene units and between 1% and 80% by weight of vinylaromatic units. The elastomers may have any microstructure, which depends on the polymerization conditions used, especially on the presence or absence of a modifying and/or randomizing agent and on the amounts of modifying and/or randomizing agent employed. The elastomers may, for example, be block, statistical, sequential or microsequential elastomers and may be prepared in dispersion or in solution; they may be coupled and/or star-branched or else functionalized with a coupling and/or star-branching or functionalization agent. Mention may be made, for example, for coupling to carbon black, of functional groups comprising a C-Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of vinylaromatic diene elastomers (such as SBR) of the epoxidized type.

Preferably, the vinylaromatic diene elastomer of the composition in accordance with the invention has a vinylaromatic content of more than 10%, preferably of between 10% and 50%, more preferably between 10% and 30%, very preferably between 12% and 28% and even more preferably between 14% and 20%. More preferably, the vinylaromatic diene elastomer of the composition in accordance with the invention is a styrenic diene elastomer (that is to say that the vinylaromatic part is a styrenic part) with a styrene content of more than 10%, preferably of between 10% and 50%, more preferably between 10% and 30%, very preferably between 12% and 28% and even more preferably between 14% and 20%.

Preferably, the vinylaromatic diene elastomer of the composition in accordance with the invention is selected with preference from the group of highly unsaturated styrenic diene elastomers consisting of styrenic copolymers of butadiene, styrenic copolymers of isoprene and mixtures of these elastomers. Such copolymers are more preferably selected from the group consisting of butadiene-styrene copolymers (SBR), isoprene-styrene copolymers (SIR) and isoprene-butadiene-styrene copolymers (SBIR).

The following are especially suitable: butadiene-styrene copolymers (SBR) and in particular those with a Tg (glass transition temperature), measured by DSC according to standard ASTM D3418 from 1999, of between 20° C. and −70° C. and more particularly between 0° C. and −50° C., a styrene content of more than 10%, preferably of between 10% and 50%, more preferably between 10% and 30%, very preferably of between 12% and 28% by weight and more preferably still between 14% and 20%, a content (mol %) of—1,2 bonds in the butadiene part of between 4% and 75%, and a content (mol %) of trans-1,4 bonds of between 10% and 80%.

The following are also suitable: isoprene-styrene copolymers (SIR) and especially those having a styrene content of between 15% and 60% by weight and more particularly between 20% and 50%, and a Tg, measured by DSC according to standard ASTM D3418 from 1999, of between 25° C. and −50° C.

In the case of butadiene-styrene-isoprene copolymers (SBIR), those having a styrene content of between 15% and 50% by weight and more particularly of between 20% and 50%, an isoprene content of between 15% and 60% by weight and more particularly between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene-styrene-isoprene copolymer having a Tg, measured by DSC according to standard ASTM D3418 from 1999, of between 20° C. and −60° C., are especially suitable.

Very preferably, the vinylaromatic diene elastomer of the composition in accordance with the invention is an SBR. In a known way, SBR may be prepared as emulsion (ESBR) or prepared as solution (SSBR).

The compositions of the invention may contain a single vinylaromatic diene elastomer or a mixture of several vinylaromatic diene elastomers, with the vinylaromatic diene elastomers(s), always predominant, being able to be used in combination with other elastomers known to those skilled in the art, such as for example a natural rubber (NR) or a polybutadiene (BR).

The vinylaromatic diene elastomer content is within a range from 70 to 100 phr, more preferably from 85 to 100 phr, and very preferably this content is 100 phr, meaning that there are only vinylaromatic diene elastomers in the composition.

II.2. Reinforcing Filler

Use may be made of any type of reinforcing filler known for its abilities to reinforce a rubber composition which can be used for the manufacture of tyres, for example an organic filler, such as carbon black, a reinforcing inorganic filler, such as silica, or else a blend of these two types of filler, in particular a blend of carbon black and silica.

All carbon blacks, especially blacks of the HAF, ISAF, SAF type, conventionally used in tyres (blacks referred to as tyre grade blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, according to the intended applications, the blacks of higher series (for example N660, N683, N772). The carbon blacks might, for example, be already incorporated in an isoprenic elastomer in the form of a masterbatch (see, for example, application WO 97/36724 or WO 99/16600).

Mention may be made, as examples of organic fillers other than carbon blacks, of functionalized polyvinyl organic fillers, such as those described in applications WO-A-2006/069792, WO-A-2006/069793, WO-A-2008/003434 and WO-A-2008/003435.

“Reinforcing inorganic filler” should be understood, in the present application, by definition, as meaning any inorganic or mineral filler (irrespective of its colour and its origin: natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of micropearls, of granules, of beads or any other appropriate densified form. Of course, reinforcing inorganic filler is also intended to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica having a BET surface area and a CTAB specific surface area both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber, and the silicas with a high specific surface area as described in application WO 03/16837.

The reinforcing inorganic filler used, in particular if it is silica, preferably has a BET surface area of between 45 and 400 m²/g, more preferably of between 60 and 300 m²/g.

Preferably, the content of total reinforcing filler (carbon black and/or reinforcing inorganic filler, such as silica) is between 20 and 200 phr, more preferably between 30 and 160 phr, the optimum being, in a known way, different depending on the specific applications targeted: the level of reinforcement expected for a bicycle tyre, for example, is, of course, less than that required for a tyre capable of running at high speed in a sustained manner, for example a motorcycle tyre, a tyre for a passenger vehicle or a tyre for a utility vehicle, such as a heavy-duty vehicle.

According to a first preferred embodiment of the invention, carbon black is used as predominant reinforcing filler, at between 60 and 160 phr and more preferably between 70 and 150 phr.

According to another preferred embodiment of the invention, use is made of silica as predominant reinforcing filler at between 60 and 160 phr, more preferably between 70 and 150 phr, and optionally of carbon black; the carbon black, when it is present, is preferably used at a content of less than 20 phr, more preferably of less than 10 phr (for example between 0.1 and 5 phr).

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer, in particular of bifunctional organosilanes or polyorganosiloxanes.

Use is especially made of silane polysulfides, referred to as “symmetrical” or “asymmetrical” depending on their particular structure, as described for example in applications WO 03/002648 (or US 2005/016651) and WO 03/002649 (or US 2005/016650).

In particular, without the definition below being limiting, silane polysulfides referred to as “symmetrical”, corresponding to the following general formula, are

Z—A—Sx—A—Z, in which:
x is an integer from 2 to 8 (preferably from 2 to 5);
A is a divalent hydrocarbon radical (preferably C₁-C₁₈ alkylene groups or C₆-C₁₂ arylene groups, more particularly C₁-C₁₀ alkylenes, especially C₁-C₄ alkylenes, in particular propylene);
Z corresponds to one of the formulae below:

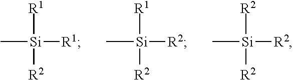

in which:
the radicals R¹, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl).
the radicals R², which are substituted or unsubstituted and identical to or different from one another, represent a C₁-C₁₈ alkoxy or C₅-C₁₈ cycloalkoxy group (preferably a group selected from C₁-C₈ alkoxys and C₅-C₈ cycloalkoxys, more preferably still a group selected from C₁-C₄ alkoxys, in particular methoxy and ethoxy).

In the case of a mixture of alkoxysilane polysulfides corresponding to the above formula, especially customary commercially available mixtures, the mean value of the “x” indices is a fractional number preferably of between 2 and 5, more preferably close to 4. However, the invention may also advantageously be carried out, for example, with alkoxysilane disulfides (x=2).

Mention will more particularly be made, as examples of silane polysulfides, of bis((C₁-C₄)alkoxy(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂. Mention will also be made, as preferred examples, of bis(mono(C₁-C₄)alkoxydi(C₁-C₄)alkylsilylpropyl) polysulfides (in particular disulfides, trisulfides or tetrasulfides), more particularly bis(monoethoxydimethylsilylpropyl) tetrasulfide, as described in patent application WO 02/083782 (or US 2004/132880).

Mention will in particular be made, as coupling agent other than alkoxysilane polysulfide, of bifunctional POSs (polyorganosiloxanes), or else of hydroxysilane polysulfides (R²=OH in the above formula), as described in patent applications WO 02/30939 (or U.S. Pat. No. 6,774,255) and WO 02/31041 (or US 2004/051210), or else of silanes or POSs bearing azodicarbonyl functional groups, as described, for example, in patent applications WO 2006/125532, WO 2006/125533 and WO 2006/125534.

In the rubber compositions in accordance with the invention, the content of coupling agent is preferably between 4 and 16 phr, more preferably between 5 and 15 phr.

Those skilled in the art will understand that, as filler equivalent to the reinforcing inorganic filler described in the present section, a reinforcing filler of another nature, in particular organic nature, could be used, provided that this reinforcing filler is covered with an inorganic layer, such as silica, or else comprises functional sites, in particular hydroxyl sites, at its surface that require the use of a coupling agent in order to form the bond between the filler and the elastomer.

II.3. PPE Resin

The composition according to the invention comprises a polyphenylene ether resin (abbreviated to “PPE resin”). This type of compound is described for example in the encyclopaedia “Ullmann's Encyclopedia of Industrial Chemistry” published by VCH, vol. A 21, pages 605-614, 5^{th} edition, 1992.

In a known way, PPE resins usually have number-average molecular masses (Mn) which are variable, most often from 15 000 to 30 000 g/mol; in the case of high masses such as these, Mn is measured in a way known to those skilled in the art by SEC (also referred to as GPC, as in reference U.S. Pat. No. 4,588,806, column 8).

For the purposes of the invention, a PPE resin is used for the composition of the invention that has an Mn mass which is lower than the masses usually encountered and especially within a range from 800 to 1500 g/mol, preferably from 800 to 1300 g/mol, and more particularly an Mn within a range from 800 to 1100 g/mol. The molecular masses are measured according to the method described above.

A number of types of structure may correspond to the PPE resins, depending on the chain sequence of the monomers. For example, there may be structures of type A or B.

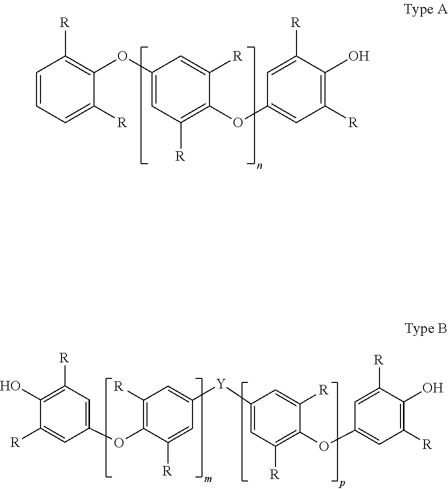

The formulae of type A and B are examples, and there are other possible structures for PPE resins. The formulaes of type A and B are available commercially, examples being the resin Noryl SA 120 (Mn=3300 g/mol by the method described above) and the resin Noryl SA 90 (Mn=2300 g/mol by the method described above), respectively, from SABIC Innovative Plastics.

Preparation of PPE Resins with a Molecular Mass within a Range from 800 to 1500 g/mol

PPE resins of type A and B having a low molecular mass may be obtained starting from commercial PPE resins with a higher molecular mass, such as Noryl SA 120 and Noryl SA90, by selective extraction of the low molecular masses contained in these products. This selective extraction was carried out by prior dissolution in a good solvent for the products, followed by controlled precipitation through the addition of a poor solvent.

Preparation of the PPE Resin of type A with Molecular Mass of 950 g/mol (Designated Resin A1)

1 kg of Noryl SA120 PPE resin is mixed with 3 kg of toluene at 60° C. The mixture is stirred until the PPE resin is completely dissolved. Then 20 kg of methanol are added and the mixture is stirred for 30 minutes for homogenization. The suspension is allowed to cool freely to ambient temperature, and the precipitate is separated from the supernatant by decanting. The solvents of the supernatant are removed by evaporation. The product recovered is 0.12 kg of a green-yellow powder. The resin A1 is a PPE resin of general formula (I), of type A, in which the groups R are methyl radicals and n=8.

Preparation of the PPE Resin of Type B with Molecular Mass of 950 g/mol (Designated Resin B1):

1 kg of Noryl SA90 PPE resin is mixed with 3 kg of toluene at 60° C. The mixture is stirred until the PPE resin is completely dissolved. Then 42.8 kg of methanol are added and the mixture is stirred for 30 minutes for homogenization. The suspension is allowed to cool freely to ambient temperature, and the precipitate is separated from the supernatant by decanting. The solvents of the supernatant are removed by evaporation. The product recovered is 0.3 kg of a yellow powder. The resin B1 is a PPE resin with a general formula different from the general formula (I), of type B, in which the group Y is a dimethylmethylene group, the groups R are methyl radicals, and m+p=5.

For the purposes of the invention, the resin has the general formula (I), of type A:

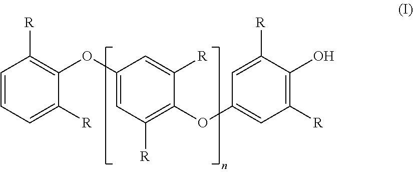

in which:
the groups R independently of one another represent a hydrogen atom or an alkyl radical; the groups R preferably all represent a hydrogen atom or all represent an alkyl radical (preferably methyl, ethyl, propyl and butyl), and more preferably the groups R represent a methyl radical.
n is between 6 and 12, preferably between 7 and 10.

The polydispersity index Ip (reminder: Ip=Mw/Mn where Mw is weight-average molecular mass and Mn is number-average molecular mass) of the PPE resin preferably has a value of less than or equal to 5, more preferably less than equal to 3 and more preferably still less than or equal to 2.

The PPE resin useful for the purposes of the invention preferably has a glass transition temperature (Tg), measured by DSC according to standard ASTM D3418 from 1999, within a range from 0 to 130° C., preferably from 5 to 115° C. and more preferably from 5 to 100° C.

The content of PPE resin in the composition is preferably within a range from 1 to 90 phr, more preferably from 2 to 80 phr, more preferably still from 3 to 60 phr and very preferably from 5 to 60 phr.

II.4. Crosslinking System

The crosslinking system can be a vulcanization system; it is preferably based on sulfur or sulfur donors and on primary vulcanization accelerator (preferably 0.5 to 10.0 phr of primary accelerator). Additional to this vulcanization system are optionally various known secondary vulcanization accelerators and/or vulcanization activators, such as zinc oxide (preferably for 0.5 to 10.0 phr), stearic acid or others. The sulfur is used at a preferred content of between 0.5 and 10 phr, more preferably of between 0.5 and 5.0 phr, for example between 0.5 and 3.0 phr when the invention is applied to a tyre tread.

Use may be made, as (primary or secondary) accelerator, of any compound capable of acting as accelerator of the vulcanization of diene elastomers in the presence of sulfur, especially accelerators of the thiazole type and their derivatives and accelerators of the thiuram and zinc dithiocarbamate types. These accelerators are more preferably selected from the group consisting of 2-mercaptobenzothiazyl disulfide (abbreviated to “M BTS”), N-cyclohexyl-2-benzothiazylsulfenamide (abbreviated to “CBS”), N,N-dicyclohexyl-2-benzothiazylsulfenamide (abbreviated to “DCBS”), N-(tert-butyl)-2-benzothiazylsulfenamide (abbreviated to “TBBS”), N-(tert-butyl)-2-benzothiazylsulfenimide (abbreviated to “TBSI”), zinc dibenzyldithiocarbamate (abbreviated to “ZBEC”) and the mixtures of these compounds. Preferably, use is made of a primary accelerator of the sulfenamide type.

II.5. Various Additives

The rubber compositions of the treads in accordance with the invention also comprise all or some of the usual additives generally used in elastomer compositions intended for the manufacture of treads, such as, for example, pigments, protection agents, such as antiozone waxes, chemical antiozonants, antioxidants, antifatigue agents, reinforcing resins or plasticizing agents. Preferably, this plasticizing agent is a solid hydrocarbon-based resin other than the resin described above (or plasticizing resin), an extending oil (or plasticizing oil) or a mixture of the two.

These compositions may also comprise, in addition to the coupling agents, coupling activators, agents for covering the inorganic fillers or more generally processing aids which are capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

II.6. Preparation of the Rubber Compositions

The compositions used in the treads of the invention can be manufactured in appropriate mixers, using two successive phases of preparation well known to those skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) to a lower temperature, typically of less than 110° C., for example between 40° C. and 100° C., during which finishing phase the crosslinking system is incorporated.

The process for preparing such compositions comprises, for example, the following steps:
incorporating into the elastomers, especially the vinylaromatic diene elastomer, during a (“non-productive”) first step, the reinforcing filler, the PPE resin and optional other ingredients of the composition with the exception of the crosslinking system, by thermomechanically kneading everything (for example once or several times) until a maximum temperature of between 110° C. and 190° C. is attained;
cooling the combined mixture to a temperature of less than 100° C.;
subsequently incorporating, during a (“productive”) second step, a crosslinking system;
kneading everything to a maximum temperature of less than 110° C.

By way of example, the non-productive phase is carried out in a single thermomechanical step during which, firstly, all the necessary base constituents (elastomers, reinforcing filler, PPE resin and others) are introduced into an appropriate mixer, such as a standard internal mixer, followed secondly, for example after kneading for one to two minutes, by the other additives, optional additional agents for covering the filler or optional additional processing aids, with the exception of the crosslinking system. The total duration of kneading in this non-productive phase is preferably between 1 and 15 min. After cooling of the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min.

The final composition thus obtained can subsequently be calendered, for example in the form of a sheet or of a slab, especially for laboratory characterization, or else extruded, for example in order to form a rubber profiled element used in the manufacture of a tyre.

The invention relates to the tyres and the semi-finished products for tyres described above, rubber articles, both in the raw state (that is to say, before curing) and in the cured state (that is to say, after crosslinking or vulcanization).

II.7. Tyre of the Invention

The rubber composition according to the invention may be used in different parts of the tyre, in particular in the crown, the carcass, the area of the bead, the area of the sidewall and the tread (including especially the underlayer of the tread).

According to one preferred embodiment of the invention, the rubber composition described above may be used in the tyre as a stiff elastomer layer in at least one part of the tyre.

The term elastomer “layer” is understood to mean any three-dimensional element, made of rubber (or “elastomer”, the two being regarded as synonyms) composition, having any shape and thickness, in particular sheet, strip or other element having any cross section, for example rectangular or triangular.

First of all, the elastomer layer may be used as a tread underlayer positioned in the crown of the tyre between, on the one hand, the tread, i.e. the portion intended to come into contact with the road during running, and, on the other hand, the belt reinforcing the said crown. The thickness of this elastomer layer is preferably within a range from 0.5 to 10 mm, especially within a range from 1 to 5 mm.

According to another preferred embodiment of the invention, the rubber composition according to the invention may be used to form an elastomer layer positioned in the region of the area of the bead of the tyre, radially between the carcass ply, the bead wire and the turn-up of the carcass ply.

Another preferred embodiment of the invention can be the use of the composition according to the invention to form an elastomer layer positioned in the area of the sidewall of the tyre.

Alternatively, the composition of the invention may advantageously be used in the tread of the tyre.

III. Exemplary Embodiments of the Invention

III.1. Preparation of the Compositions

The following tests are carried out in the following way: the vinylaromatic diene elastomer, the reinforcing filler and the PPE resin, and also the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one step, which lasts in total approximately from 3 to 4 min, until a maximum “dropping” temperature of 180° C. is reached.

The mixture thus obtained is recovered and cooled and then sulfur and an accelerator of sulfenamide type are incorporated on a mixer (homofinisher) at 30° C., everything being mixed (productive phase) for an appropriate time (for example between 5 and 12 min).

The compositions thus obtained are subsequently calendered, either in the form of slabs (thickness from 2 to 3 mm) or of thin sheets of rubber, for the measurement of their physical or mechanical properties, or extruded in the form of a profiled element.

III.2. Tests on Rubber Compositions

This test illustrates rubber compositions used in tyre treads. These compositions make it possible to increase the Tg of the mixture. For this purpose, rubber compositions were prepared as indicated above.

The composition C1 below contains no PPE resin. The control compositions C2, C3 and C4 comprise PPE resins which are not in accordance with the present invention. The composition C5 is in accordance with the invention. The formulations (in phr or parts by weight per 100 parts of elastomer) and the mechanical properties thereof have been summarized in Tables 1 and 2 below.

TABLE 1

| Composition | C1 | C2 | C3 | C4 | C5 |
|---|---|---|---|---|---|
| SBR (1) | 100 | 100 | 100 | 100 | 100 |
| Silica (2) | 70 | 85 | 85 | 85 | 85 |
| Silane (3) | 5 | 7 | 7 | 7 | 7 |
| PPE Resin 1 (4) | — | 25 | — | — | — |
| PPE Resin 2 (5) | — | — | 25 | — | — |
| PPE Resin 3 (6) | — | — | — | 25 | — |
| PPE Resin 4 (7) | — | — | — | — | 25 |
| DPG (8) | 1 | 1.5 | 1.5 | 1.5 | 1.5 |
| ZnO (9) | 3 | 3 | 3 | 3 | 3 |
| Stearic acid (10) | 2 | 2 | 2 | 2 | 2 |
| 6PPD (11) | 2 | 2 | 2 | 2 | 2 |
| Sulfur | 1 | 1 | 1 | 1 | 1 |
| CBS (12) | 2.5 | 2.5 | 2.5 | 2.5 | 2.5 |

(1) SBR with 15% styrene unit and 24% 1,2 unit of the butadiene part (Tg measured by DSC according to standard ASTM D3418 from 1999 of −65° C.);
(2) Zeosi11165MP silica from Solvay with BET surface area of 160 m²/g;
(3) TESPT coupling agent: SI69 from Evonik;
(4) PPE Resin 1: poly(2,6-dimethyl-1,4-phenylene ether) Noryl SA120 from Sabic, Mn = 3300 g/mol;
(5) PPE Resin 2: poly(2,6-dimethyl-1,4-phenylene ether) Noryl SA90 from Sabic, Mn = 2350 g/mol;
(6) PPE Resin 3: PPE B1 resin obtained by the procedure described above, with Mn = 950 g/mol;
(7) PPE Resin 4: PPE A1 resin obtained by the procedure described above, with Mn = 950 g/mol;
(8) Diphenylguanidine: Perkacit DPG from Flexsys;
(9) Zinc oxide (industrial grade-Umicore);
(10) Stearin (Pristerene 4931 from Uniquema);
(11) N-1,3-Dimethylbutyl-N-phenyl-para-phenylenediamine Santoflex 6-PPD from Flexsys;
(12) N-Cyclohexylbenzothiazylsulfenamide (Santocure CBS from Flexsys).

TABLE 2

| Composition | C1 | C2 | C3 | C4 | C5 |
|---|---|---|---|---|---|
| Tg (° C.) | −55 | −54 | −51 | −51 | −47 |

It is seen that the compositions C2 and C3 have glass transition temperatures which are close to and greater than that of the high-Tg, plasticizer-free composition C1. In composition C4, it is seen that the switch to a lower Mn of a PPE resin of type B has little effect on its capacity to modify the Tg of the mixture. Conversely, and surprisingly, it is found in C5 that for the PPE resin of type A, a decrease in the Mn leads to a markedly more heightened increase in the Tg of the mixture. It was also found, surprisingly, that the composition C5 in accordance with the invention has a much higher Tg than the composition C4, despite the fact that the PPE resins contained in these compositions have a comparable molecular mass.

1.-23. (canceled)

24. A rubber composition based on:
at least one predominant vinylaromatic diene elastomer;
a reinforcing filler;
a crosslinking system;
and a polyphenylene ether resin which has a number-average molecular mass Mn within a range from 800 to 1500 g/mol and a general formula (I) 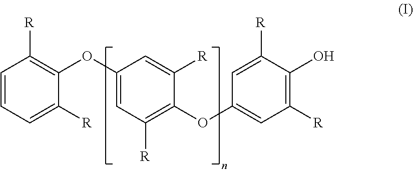
in which groups R, independently of one another, represent a hydrogen atom or an alkyl radical and in which n is between 6 and 12.

25. The rubber composition according to claim 24, wherein the polyphenylene ether resin has a number-average molecular mass Mn within a range from 800 to 1300 g/mol.

26. The rubber composition according to claim 25, wherein the polyphenylene ether resin has a number-average molecular mass Mn within a range from 800 to 1100 g/mol.

27. The rubber composition according to claim 24, wherein the vinylaromatic diene elastomer has a vinylaromatic content of more than 10%.

28. The rubber composition according to claim 27, wherein the vinylaromatic diene elastomer has a vinylaromatic content of between 10% and 50%.

29. The rubber composition according to claim 28, wherein the vinylaromatic diene elastomer has a vinylaromatic content of between 12% and 28%.

30. The rubber composition according to claim 24, wherein the vinylaromatic diene elastomer is selected from the group consisting of copolymers of butadiene and styrene, copolymers of isoprene and styrene, copolymers of butadiene, isoprene and styrene, and mixtures thereof.

31. The rubber composition according to claim 24, wherein a vinylaromatic diene elastomer content is within a range from 70 to 100 phr.

32. The rubber composition according to claim 24, wherein the polyphenylene ether resin has a glass transition temperature Tg, measured by DSC according to standard ASTM D3418 from 1999, within a range from 0 to 130° C.

33. The rubber composition according to claim 24, wherein the polyphenylene ether resin has the general formula (I) in which the groups R all represent a hydrogen atom or all represent an identical alkyl radical.

34. The rubber composition according to claim 24, wherein the groups R represent a methyl radical.

35. The rubber composition according to claim 24, wherein n is between 7 and 10.

36. The rubber composition according to claim 24, wherein a content of the polyphenylene ether resin is within a range from 1 to 90 phr.

37. The rubber composition according to claim 36, wherein the content of the polyphenylene ether resin is within a range from 3 to 60 phr.

38. The rubber composition according to claim 24, wherein the reinforcing filler comprises carbon black, silica, or both carbon black and silica.

39. The rubber composition according to claim 24, wherein a content of the reinforcing filler is between 20 and 200 phr.

40. The rubber composition according to claim 24, wherein the reinforcing filler comprises predominantly carbon black.

41. The rubber composition according to claim 40, wherein a content of the carbon black is from 60 to 160 phr.

42. The rubber composition according to claim 24, wherein the reinforcing filler comprises predominantly silica.

43. The rubber composition according to claim 42, wherein a content of the silica is from 60 to 160 phr.

44. A finished or semi-finished rubber article comprising a rubber composition according to claim 24.

45. A tire comprising the rubber composition according to claim 24.

46. A tire according to claim 45, wherein a tread comprises the rubber composition.
